(19) United States
(12) Patent Application Publication
(10) Pub. No.: US 2026/0104160 A1
(43) Pub. Date: Apr. 16, 2026

(54) HELIOS LIGHT TRACK CONTROLLING SYSTEM AND METHOD

(71) Applicant: Paul F. Getsy, Eastlake, OH (US)

(72) Inventor: Paul F. Getsy, Eastlake, OH (US)

(21) Appl. No.: 19/357,305

(22) Filed: Oct. 14, 2025

Related U.S. Application Data
(60) Provisional application No. 63/707,176, filed on Oct. 14, 2024.

(51) Int. Cl. F21V 21/15; A01K 29/00; F21V 21/34

(52) U.S. Cl. CPC F21V 21/15; A01K 29/004; F21V 21/34

(57) ABSTRACT

A light track controlling system and method of operation is provided. The light track controlling system includes a light track apparatus for use with an animal enclosure having a track positioned above the animal enclosure and extending along a length of the animal enclosure, a moveable carriage coupled to the track and configured to move along the track, a home limit switch located at a first end of the track and a return limit switch located at a second end of the track and opposite the first end, a motor coupled to the moveable carriage, and a control module electrically coupled to the motor, wherein the control module includes a timer to control movement of the moveable carriage from a home position to a return position on the track.

### CROSS REFERENCE TO RELATED APPLICATIONS

The following application claims priority under 35 U.S.C. § 119 (e) to U.S. Provisional Patent Application Serial No. 63/707176 filed October 14, 2024 entitled HELIOS SYSTEM: METHOD FOR CONTROLLING LIGHT TRACK SYSTEM FOR USE IN HERPETOCULTURE. The above-identified application is incorporated herein by reference in its entirety for all purposes.

### TECHNICAL FIELD

The present disclosure generally relates to a light track controlling system and method of operation, and more particularly to a light track controlling system that controls a heat and light source housed in a moveable carriage that moves across a track from one end to an opposite end over the course of a predetermined time interval and installed over an animal enclosure.

### BACKGROUND

Reptiles are exotherms, so their internal body temperatures are regulated by their surrounding environments. Regulation of body temperature may occur through basking behavior to directly warm their skin from sunlight exposure, or alternatively, from the heat released on warm surfaces such as rocks. To lower their body temperatures, reptiles will find a shaded area away from the sunlight. Reptiles perform these body regulation activities constantly, and as such, captive settings must provide both a cool and a warm zone, for example, within an animal enclosure.

For diurnal animals, or animals active during the day, a heat bulb may be situated at one end of their enclosed habitat, while a UVB, or ultraviolet B, bulb is placed on the opposing end. UVB bulbs are not a significant source of heat and are readily used to provide luminescence within the animal enclosure. This setup creates an environment where there is a stable hot area under the heat bulb, and cool zone under the UVB bulb. This bi-zone setup provides reptiles the ability to regulate their internal body temperature and thus their physiological functions, such as regulating their metabolism.

Even though this scheme provides a method of creating hot/cool zones, it is unnatural. For example, the sun does not remain in one place in the sky throughout the day. The earth rotates towards the east; thus, the sun rises in the morning from the east. As the day progresses, the earth continues to rotate and the sun will move westward across the sky, eventually setting in the west. Accordingly, the stationary lighting setup recommended in many animal care-guides is rudimentary. Since the animals must go to the same area in the enclosure when they need to warm themselves, it becomes repetitive.

### BRIEF DESCRIPTION

According to one aspect, a light track apparatus for use with an animal enclosure includes a track positioned above the animal enclosure and extending along a length of the animal enclosure. The apparatus includes a moveable carriage coupled to the track and configured to move along the track, a home limit switch located at a first end of the track and a return limit switch located at a second end of the track and opposite the first end, a motor coupled to the moveable carriage, and a control module electrically coupled to the motor. The control module includes a timer to control movement of the moveable carriage from a home position to a return position on the track.

According to another aspect, a method of operation for a light track apparatus includes transitioning a control module from a standby mode to an active mode by supplying power to the light track apparatus. The method includes programming a timer in the control module with a time interval for a moveable carriage to travel from a home position to a return position along a track. The method includes energizing a motor to transfer the moveable carriage to the home position and advancing the moveable carriage across a length of the track away from the home position for the time interval programmed in the timer, while simultaneously energizing a light source. The method includes stopping advancement of the moveable carriage at the return position after the time interval has elapsed, de-energizing the light source, and returning the moveable carriage back to the home position.

According to another aspect, a system for controlling a light track system for use in an animal enclosure includes a control module with an electrical power input and output, the control module coupled to a motor for moving a moveable carriage. The system also includes a home limit switch located at a first end of a track and a return limit switch located at a second end of the track and opposite the first end. The moveable carriage is configured to move on the track from a home position of the track to a return position of the track. A light source is energized while the moveable carriage is moving from the home position to the return position of the track. The moveable carriage is coupled to a belt that is connected to the motor. When the motor is energized, the belt moves the moveable carriage along the track. The moveable carriage begins a cycle at the home position of the track and progresses to the return position of the track over a time interval that has been programmed into the control module through an interface on the control module. The moveable carriage travels back to the home position after reaching the return position and remains at the home position until another cycle begins.

### BRIEF DESCRIPTION OF THE DRAWINGS

The accompanying drawings, which are incorporated in and constitute a part of the specification, illustrate various systems, methods, devices, and other embodiments of the disclosure. It will be appreciated that the illustrated element boundaries (e.g., boxes, groups of boxes, directional lines, or other shapes) in the figures represent one embodiment of the boundaries. In some embodiments, one element may be designed as multiple elements or that multiple elements may be designed as one element. In some embodiments, an element shown as an internal component of another element may be implemented as an external component and vice versa. Like references numerals refer to like parts throughout the drawings unless described otherwise. Furthermore, elements may not be drawn to scale.

FIG. 1 is a frontal view of one embodiment of a light track controlling system and method disclosed herein;

FIG. 2 is a perspective view of one embodiment of a moveable carriage for a light source mounted on a track;

FIG. 3 is a perspective view of an endplate and the several mounting and sizing holes therein;

FIG. 4 is a perspective view of the alternate endplate and the control module attached thereto;

FIG. 5 is a plan view of one embodiment of a light track controlling system;

FIG. 6 is a perspective view of a moveable carriage with a lamp shade attachment;

FIG. 7 is a front perspective view of a light track controlling system having front cover attachments secured to endplates;

FIG. 8 is a front perspective view of another embodiment of a light track controlling system having a rail coupler attached;

FIG. 9 is a communication infrastructure in a control module for a light track controlling system according to one exemplary embodiment; and

FIG. 10 is a schematic diagram illustrating a method of operating a light track controlling system in accordance with one example embodiment of the present disclosure.

### DETAILED DESCRIPTION

For animals such as reptiles, whose very existence is dependent upon their ability to warm themselves effectively, heat and lighting conditions may impact their ability to perform other activities needed for their survival, such as hunting and eating. Accordingly, one could expect the close solar relationship to result in the development of advantageous bodily features. For instance, to increase the efficiency of the time spent basking in the sun, some species in the Order Squamata, which includes lizards, have evolved to possess a photosensitive organ called the parietal eye. Multiple functions have been proposed for this organ, including predatory evasion, navigation, hormone regulation for thermoregulation, and as an illuminator. Regardless of whether this organ’s role is either one or several of these functions, they all relate to the sun and in some cases the location of the sun in the sky. It is therefore believed that the current state of a motionless lighting setup in animal enclosures may create a confusing environment for these animals, and a moveable light source may improve outcomes for reptiles and other animals living in enclosures.

Referring now to the figures generally wherein like numbered features shown therein refer to like elements throughout unless otherwise noted. The present disclosure relates to a light track controlling system and method of operation, and more particularly to a light track controlling system for use with an animal enclosure that provides input to a moveable carriage housing a light source as the moveable carriage moves across a track from one end to an opposite end over a predetermined time interval programmed in a control module to emulate movement of the sun across the sky. The light track controlling system will be positioned above an animal enclosure and extending in a length as defined by a width of the animal enclosure.

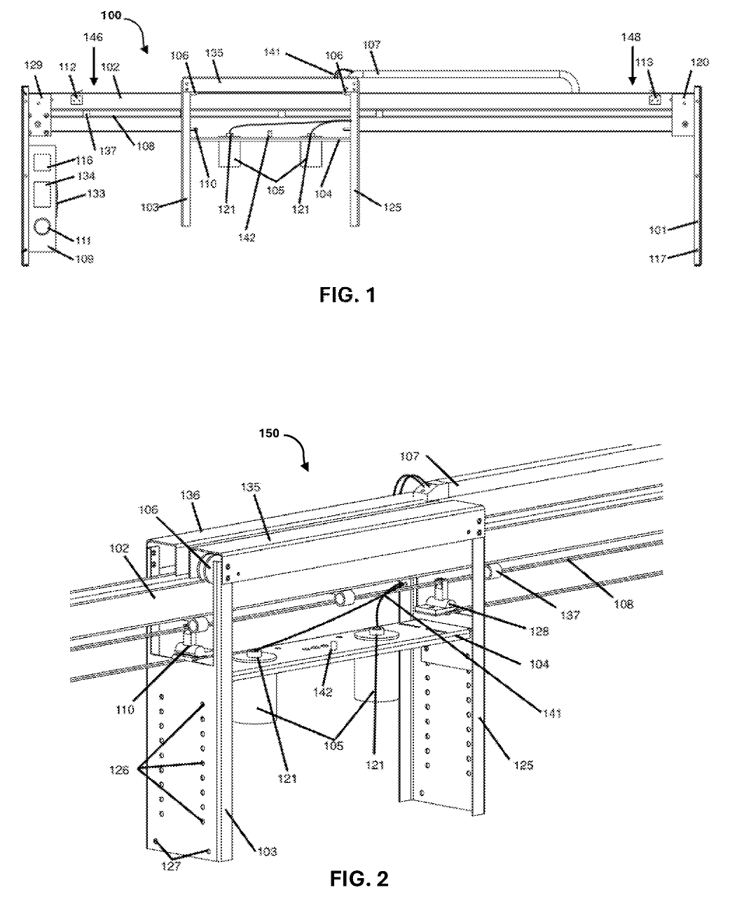

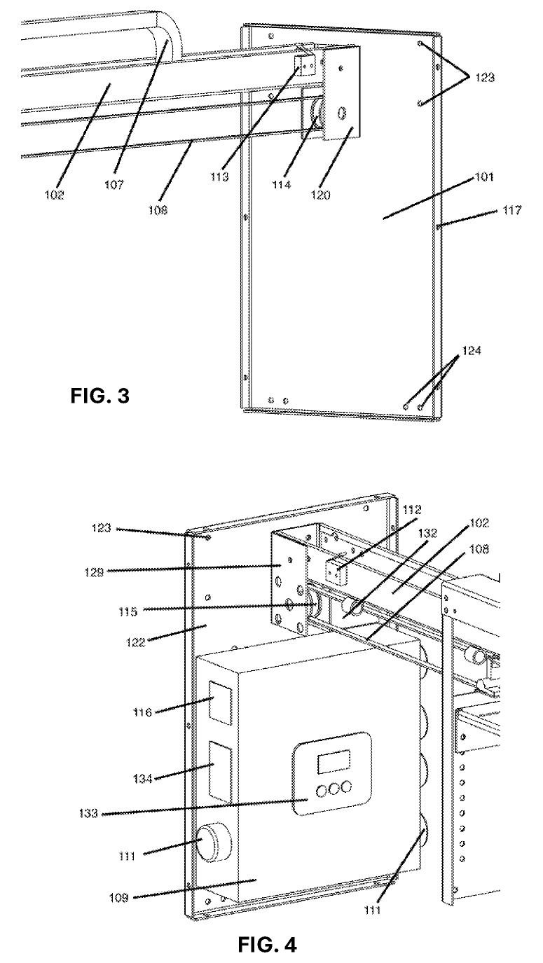

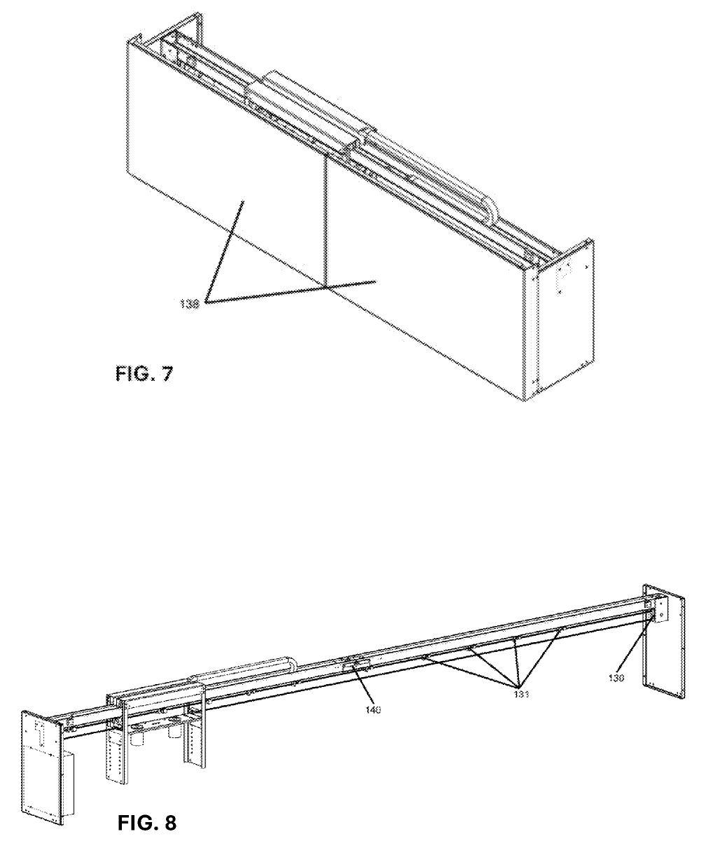

FIG. 1 illustrates a frontal view of a light track controlling system 100 in accordance with one example embodiment. The structural components of the light track controlling system 100 are constructed from 316 stainless steel in one example embodiment, but may be constructed from other materials known to those having ordinary skill in the art. The end frames 101, 122 provide support for the light track controlling system 100 and may be manufactured from stamped sheet metal having all four edges designed to fold inward. The end frames 101, 122 include a plurality of strategically cut holes 117, 123, and 124 shown in FIGS. 3 and 4 that allow for mounting of the light track controlling system 100 in various positions or for installing components such as a front cover 138. For example, the upper holes 123 cut towards the top of the end frames 101 and 122 allow for installation of a bracket (not shown) to mount the light track controlling system 100 from a hanging position such as from a ceiling. The lower holes 124 cut towards the bottom of the end frames 101, 122 allow for installation of a bracket (not shown) to add rigidity to the light track controlling system 100 or for mechanical coupling to the top of an animal enclosure. The holes 117, 123, and 124 cut along the folded edges of the end frames 101, 122 allow for installation of the front cover 138 shown in FIG. 7 and spans across the length of the light track controlling system 100.

Continuing with FIGS. 1, 3, and 4, the plurality of holes 117, 123, and 124 in the end frames 101, 122 include additional holes for mounting an electrical housing unit 109 on a first end frame 122, although the electrical housing unit 109 may be mounted on either the first or a second end frame 101 or 122. Also included in the first and second end frames 101, 122 are holes to mechanically couple a first and second bracket 120, 129. These brackets 120, 129 serve to couple the end frames 101, 122 to a track 102 of various lengths displaced therebetween. The track 102 is three feet in length in one example embodiment, four feet in another example embodiment, five feet in another example embodiment, and six feet long in yet another example embodiment. Longer segments of track 102 may be joined together using a coupler 140 as shown in FIG. 8. Those having ordinary skill in the art will appreciate that track 102 can be manufactured to a variety of custom lengths.

The electrical housing unit 109 contains electrical components for commanding the light track controlling system 100, such as the electronics, relays, circuits, thermostat, light dimmer, battery backup, fuses, and control module 133 shown in FIG. 4. The control module 133 is programmable to set the light track controlling system 100 ON/OFF time intervals for a light source such as heat and UVB bulbs, as well as an electric motor 132, and is selectable to the minute level of precision. The time interval will define a period of time that the light track controlling system 100 is ON and operating as the moveable carriage moves from a home position 146 to a return position 148 while the light source (e.g. heat bulbs) are simultaneously illuminated. The components housed in the electrical housing unit 109 are sealed to protect from humidity. One example embodiment utilizes a rubber gasket molded to fit in a groove fabricated in the lid of the electrical housing unit 109, wherein the communicative wires pass to and from the electrical housing unit 109 through glands 111 that are also sealed from outside moisture to protect sensitive components inside of the electrical housing unit 109. The electrical housing unit 109 also includes at least one additional electrical grounded power outlet 116. This power outlet 116 may be energized with the same ON/OFF cycle as the heat bulbs, or may be separately programmed by the control module 133, and in one example embodiment, can be used to illuminate UVB bulbs for the light track controlling system 100.

Further included with the electrical housing unit 109 is a C19 outlet 134 for input connections to the light track controlling system 100 such as a thermostat controller and/or a light dimmer. The C19 outlet 134 will provide an alternative source of electrical power to energize the heat bulbs when in use, although it is not necessary to operate the light track controlling system 100. In one example embodiment, the C19 power cord is rated for 120V and 20A, and 120V and 15A in another example embodiment. The power outlet 116 and C19 outlet 134 can each be covered by a waterproof lid when not in use, providing further protection from water and humidity to components in the electrical housing unit 109. Another example embodiment may utilize a silicone gasket to be installed in between the power outlet 116 or C19 outlet 134 and their respective power cords or plugs when in use, to further protect against water and humidity intrusion.

Continuing with FIGS. 1, 3, and 4, the brackets 120, 129 also house timing pulleys 114, 115 located at the first end frame 122 and the second end frame 101 respectively. In one example embodiment of the present disclosure, the pulleys 114, 115 are stainless steel and have forty timing teeth. It is understood that other embodiments can include pulleys of different materials, for example, plastic timing pulleys, and can have various numbers of teeth than that shown in the figures. A motor 132 may also be coupled to bracket 129 near the first end frame 122, although the motor 132 may also be attached to the opposite bracket 120 near the second end frame 101. In an example embodiment, the motor 132 is a NEMA 17 stepper motor manufactured by Changzhou Chuangyi Motor Co., LTD, having a part number of 42BYG-60 45PH26-181, and may also include an IP65 waterproof rating to prevent damage from moisture. The motor 132 may receive the pulley 115 around its output shaft and will rotate in accordance with the programmed algorithm of the control module 133.

Wrapped around each of the pulleys 114, 115 and connecting therebetween is a timing belt 108. The timing belt 108 forms a continuous path from the timing pulley 115 of the first end frame 122 to the timing pulley 114 of the second end frame 101. Two cut ends of the timing belt 108 are coupled to side carriage plates 103, 125 and facilitate sliding of a moveable carriage 150 shown in FIG. 2. Timing belt guides 110, 128 aid in supporting and keeping the timing belt 108 straight and aligned as the moveable carriage 150 slides or moves across the track 102 back and forth. Further support for the timing belt 108 to help prevent sagging are belt hangers 131 dispersed along the track 102 as shown in FIG. 8, as well as belt supports 130 located at either end of the track 102 near the timing pulleys 114, 115 and positioned to maximize engagement between the timing belt 108 and the pulleys 114, 115, further increasing accuracy of the movement of the moveable carriage 150. Belt hangers 131 and belt supports 130 may be 3D printed in one example embodiment.

Continuing with FIG. 2, the moveable carriage 150 houses at least one light source secured to a carriage platform 104. In one example embodiment shown in FIG. 2, the moveable carriage 150 houses two heat bulbs as the light source. The light source or heat bulb sockets 105 are mounted on the carriage platform 104 with a socket cap 121, and an electrical insulator such as di-electric insulation gaskets installed in between the socket 105 and the underside of the carriage platform 104 as well as between the top side of the carriage platform 104 and the socket cap 121. In an example embodiment, the sockets 105 are porcelain with ratings of 660W and 250V.

The carriage platform 104 is mounted to side carriage plates 103, 125, which have a plethora of holes 126, 127 allowing the carriage platform 104 height to be adjusted up and down, which in turn, places the light source closer or further from an animal enclosure. The holes 127 cut near the bottom of the side carriage plates 103, 125 allow for an optional mesh screen (not shown) to be fastened to the moveable carriage 150 to reduce contact with the light source. In addition, holes 126, 127 of the side carriage plates 103, 125 allow for installation of an optional lamp shade 139, as viewed in FIG. 6. The moveable carriage 150 is suspended from the track 102 through coupling with wheels 106 in contact with the track 102. Although in the example embodiment shown in FIG. 2, the wheels 106 are u-groove wheels manufactured from 304 stainless steel, it is understood that other materials may be used, such as plastics, rubbers, and other metals. Secure brackets 135, 136 couple the side carriage plates 103, 125 together from atop the track 102 and also provide securing material for each of the u-groove wheels 106. In an example embodiment shown in the figures herein, the front secure bracket 135 houses two u-groove wheels 106 and the rear secure bracket 136 houses one u-groove wheel 106.

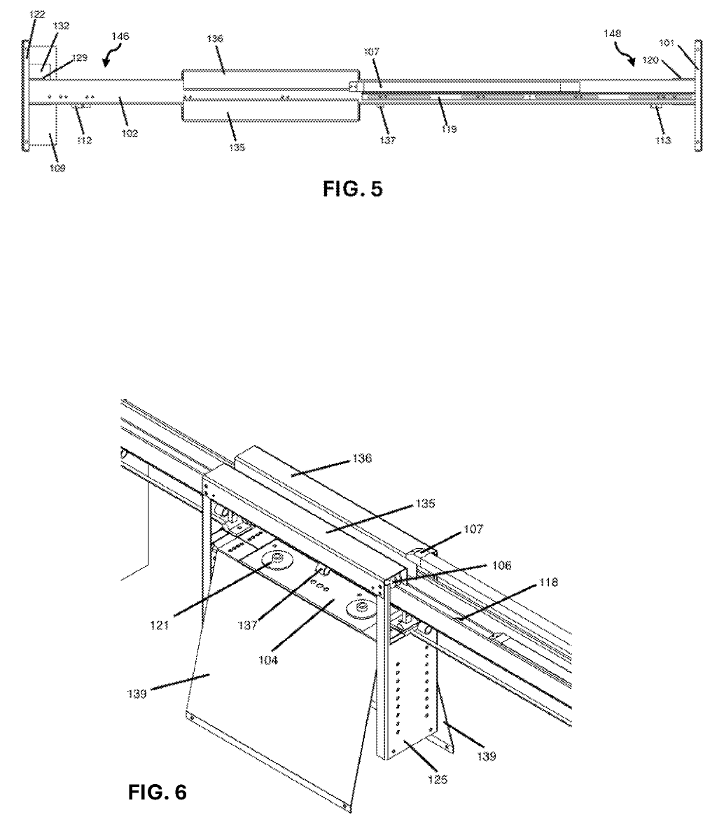

A drag chain 107 is also coupled to the top of the rear secure bracket 136, which houses the electrical wiring 141 that provides power and electrical communication from the control module 133 of the light track controlling system 100. Depicted in FIG. 2, the track 102 includes a series of holes for attaching wire mounts 137, such as plastic wire clips, or the like, used for fastening the wiring 141 from the light source and limit switches 112, 113 shown in FIGS. 3 and 4. An example of a pass through hole 118 is shown in FIG. 6, wherein electrical wires 141 from the light source may pass through the track 102 and into the u-groove of the track 102. The wires 141 may then enter the bolted end of the drag chain 107 which also rests in the groove of the track 102. The drag chain 107 remains aligned in the groove of the track 102 while operating with use of rail dividers 119, as shown in FIG. 5. A rubber grommet may be installed to protect the wires 141 from damage when traversing a pass-through hole 118.

Limit switches 112, 113 depicted in FIGS. 3 and 4 are coupled to a first end and a second end of the track 102 at opposite ends as represented in FIG. 5 and provide protection of the moveable carriage 150 and the motor 132 in one example embodiment of the present disclosure. As the motor 132 is commanded by the control module 133 to perform a series of steps to turn the pulleys 114, 115, and in turn, transport the moveable carriage 150 via the timing belt 108, the moveable carriage 150 slides from the home position 146 near the home limit switch 112 to the return position 148 near the return limit switch 113, and then slides the moveable carriage 150 all the way back to the same home position 146 near the home limit switch 112. In the event the moveable carriage 150 has advanced further than its intended placement, the moveable carriage 150 may slide into and contact the return limit switch 113 at the far end of the track 102. If the return limit switch 113 is triggered, the return limit switch 113 transmits a signal to the control module 133, which in turn, seizes advancement of the moveable carriage 150. The control module 133 then commands the motor 132 to reverse direction and move the moveable carriage 150 backwards until the home limit switch 112 is triggered. Once triggered, the home limit switch 112 transmits a signal to the control module 133, which in turn, seizes the reverse movement of the motor 132, and then advances the moveable carriage 150 to a preset home position 146.

The preset home position 146 may be, for example, 100mm advanced from the home limit switch 112 in one example embodiment, or 50mm advancement from the home limit switch 112 in another example embodiment. In yet another example embodiment of the present disclosure, the home position 146 and the return position 148 are approximately ¼ inches away from either the home limit switch 112 or the return limit switch 113 respectively. In other words, while the moveable carriage 150 is in the home position 146, there exists a ¼ inch gap between contact of the home limit switch 112 and the first side plate 103 of the moveable carriage 150, and while the moveable carriage is in the return position 148, there exists a ¼ inch gap between contact of the return limit switch 113 and the second side plate 125 of the moveable carriage 150.

If time remains in the time interval programmed into the control module 133 to represent the ON setting, the light track controlling system 100 will resume normal operations by continuing to advance the moveable carriage 150 in the direction towards the return limit switch 113 until the full time interval is reached. In one example embodiment, the control module 133 will command the motor 132 to continue operations once the home limit switch 112 is triggered and the moveable carriage 150 has been set in the home position 146 away from the home limit switch 112, and then continues moving the moveable carriage 150 along the track 102 away from the home position 146. In another example embodiment, the control module 133 includes a memory that is preserved with a battery backup in the event of power loss, that once power is restored, will resume normal operations for the programmed time interval at the placement along the track 102 where the moveable carriage 150 would have advanced to without any interruptions in its operation. In yet another embodiment, the moveable carriage 150 includes a time mark (not shown) that corresponds with time markings (not shown) on the track 102, so the time interval from advancement of the moveable carriage 150 along the track 102 can be read by aligning the time mark on the moveable carriage 150 with the time markings on the track 102. This will enable a user to manually slide the moveable carriage 150 to the proper time marking in the event of a power loss to resume normal operations once power has been restored.

The ON setting in one example embodiment of the present disclosure is twelve hours powered on for each day of operation. The control module 133 is thus programmed to advance the moveable carriage 150 across the track 102 and energize the light source for twelve hours in step-wise movements through use of a stepper-motor 132. For a three-foot section of track 102, the control module 133 will command the stepper-motor 132 to operate a total of nineteen intervals, wherein each interval consists of one-hundred and seven steps of rotating the timing pulleys 114, 115 to advance the moveable carriage 150, and with approximately thirty-six minutes delay between each of the intervals. Upon completion of the final nineteenth interval for a three-foot section of track 102, the control module 133 will pause movement of the moveable carriage 150 at the return position 148 until the full twelve hours have elapsed, before returning the moveable carriage 150 to the home position 146 for rest until another cycle begins approximately twelve hours later the following day. It is understood that the light source will be energized continuously for the twelve hours of this example embodiment.

The substantially same process repeats in another example embodiment, wherein the preprogrammed length setting of the track in the control module 133 is four feet. For a four-foot section of track 102, the control module 133 will command the stepper-motor 132 to operate a total of sixty intervals, wherein each interval consists of fifty-nine steps of rotating the timing pulleys 114, 115 to advance the moveable carriage 150 from the home position 146, and with approximately eleven minutes and forty-eight seconds delay between each of the intervals. Upon completion of the final sixtieth interval for a four-foot section of track 102, the control module 133 will pause movement of the moveable carriage 150 at the return position 148 until the full twelve hours have elapsed, before returning the moveable carriage 150 to the home position 146 for rest until another cycle begins approximately twelve hours later the following day. Although the moveable carriage 150 will advance from the home position 146 to the return position 148 in a step-wise manner throughout the time interval, the return of the moveable carriage 150 to the home position 146 after the full time interval has elapsed will occur in one continuous movement.

In yet another example embodiment, the preprogrammed length setting of the track is five feet. For a five-foot section of track 102, the control module 133 will command the stepper-motor 132 to operate a total of seventy intervals, wherein each interval consists of seventy-three steps of rotating the timing pulleys 114, 115 to advance the moveable carriage 150, and with approximately ten minutes and eight seconds delay between each of the intervals. Upon completion of the final seventieth interval for a five-foot section of track 102, the control module 133 will pause movement of the moveable carriage 150 at the return position 148 until the full twelve hours have elapsed, before returning the moveable carriage 150 to the home position 146 for rest until another cycle begins approximately twelve hours later the following day.

In still another example embodiment, the preprogrammed length setting of the track is six feet. For a six-foot section of track 102, the control module 133 will command the stepper-motor 132 to operate a total of sixty-five intervals, wherein each interval consists of one-hundred and seven steps of rotating the timing pulleys 114, 115 to advance the moveable carriage 150, and with approximately ten minutes and fifty-five seconds delay between each of the intervals. Upon completion of the final sixty-fifth interval for a six-foot section of track 102, the control module 133 will pause movement of the moveable carriage 150 at the return position 148 until the full twelve hours have elapsed, before returning the moveable carriage 150 to the home position 146 for rest until another cycle begins approximately twelve hours later the following day. Those having skill in the art with the knowledge of the present disclosure will appreciate that programming of the control module 133 can be such to accommodate various track 102 lengths and combinations of steps and interval times.

In addition to operating the moveable carriage 150 and light sources in a standard twelve hour ON cycle, the light track controlling system 100 can allow users to define custom ON and OFF times in another example embodiment. Upon user input through the control module 133, an embedded algorithm calculates the appropriate number of intervals and the corresponding step count per interval and time delay in between each interval. These calculated parameters enable the moveable carriage 150 to traverse the full length of the track 102 proportionately to the duration between the specified ON and OFF times.

An additional feature of the light track controlling system 100 in another example embodiment enables users to input geographic information pertaining to the region from which the subject in the enclosure naturally originates from. Utilizing wireless transmission such as Wi-Fi from the electrical housing unit 109, the light track controlling system 100 receives real-time sunrise and sunset data from online sources for the specified region. Based on this information, the light track controlling system 100 automatically determines and adjusts ON and OFF operation times to accurately replicate the natural photoperiod that the subject (e.g., animal) within the enclosure would experience in its native environment throughout the different seasons of the year, and adjustment appropriately for the current time zone of operation.

As mentioned above and depicted in FIG. 1, the light track controlling system 100 includes at least one additional power outlet 116 on the electrical housing unit 109. Although this outlet 116 may be energized during the same ON time interval as the light source on the moveable carriage 150, in another example embodiment, the power outlet 116 may be energized on a separately programmable schedule from the light source of the moveable carriage 150. This is specifically advantageous due to the characteristics of some fluorescent bulbs being utilized for ultraviolet light generation, which may lack the ability to be dimmed. In one embodiment of the present disclosure, the light source of the moveable carriage 150 may be dimmed from a minimum luminosity to a maximum luminosity to simulate sunrise conditions using minute-level precision, and then dimmed once again to simulate sunset conditions. The power outlet 116 having a UVB bulb plugged in can energize once the simulated sunrise has occurred, and turn off before the simulated sunset begins, thereby maintaining the integrity of the simulated sunrise and sunset cycles for UVB bulbs that cannot be dimmed.

In addition to the ability to communicate with a third-party thermostat or dimmer through the C19 outlet 134, the light track controlling system 100 may also house an integrated dimming component within the electrical housing unit 109. This integrated dimming component is configured to replicate natural solar cycles by gradually adjusting light intensity to simulate sunrise and sunset conditions through regulation of electrical current supplied to the heat and light bulbs. In an example embodiment, the moveable carriage 150 includes a plurality of infrared sensors 142 as shown in FIGS. 1 and 2. The infrared sensors 142 obtain temperature measurements from a basking zone beneath the moveable carriage 150, and communicate these temperature measurements to the control module 133. The control module 133 may then dynamically adjust the current supplied to heating bulbs to thereby regulate thermal output and maintain a desired temperature within the basking zone beneath the moveable carriage 150. Solar cycle information may be obtained via wireless communication from the electrical housing unit 109 to surrounding electronic systems.

Operating conditions for the light track controlling system 100 will now be described, where upon startup, a user provides input through the control module 133 to define a plurality of operational parameters, including current time, ON and OFF hours and minutes, dimming settings for the light bulbs, and any use of third-party thermostats and/or dimmers. A main microcontroller within the control module 133 communicates the set time to a real-time clock (RTC) module, the RTC module being configured to maintain accurate timekeeping thereafter. The RTC further comprises a battery backup configured to preserve timekeeping functionality during a power outage.

When the current time corresponds to a user-defined ON time, the main microcontroller of the control module 133 transmits control signals to a plurality of relays and to a secondary microcontroller, wherein the secondary microcontroller is configured to operate a motor driver that controls the motor 132 power, direction, speed, and step count to execute interval movement and delay operations corresponding to the daylight cycle.

The plurality of relays are arranged to direct power distribution according to user-defined parameters. In one example embodiment of the present disclosure, two of the relays are associated with a dimming function and two of the relays are associated with a standard ON/OFF function, wherein within each pair of relays, one relay controls heat bulbs and the other controls UVB bulbs. The relay circuit may further comprise at least two fuses disposed between an input power source and the relays, wherein the fuses are configured to protect system electronics from damage such as from an overcurrent condition.

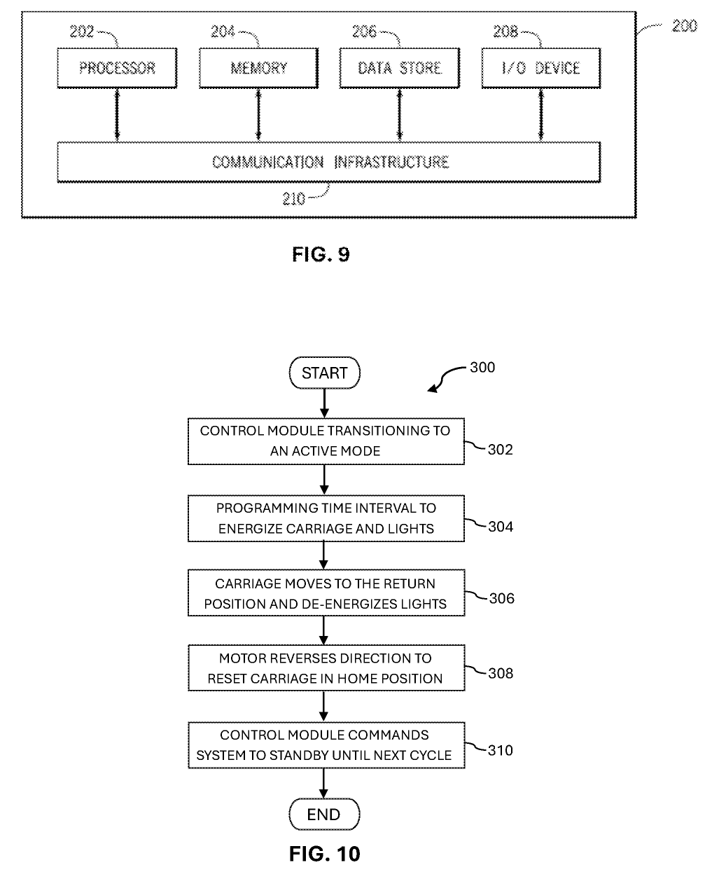

FIG. 9 depicts an exemplary computing system 200 that may be used to implement and/or execute the methods, functions, and components of the control module 133 described herein. The computing system includes a processor 202, a memory 204, a data store 206, and an I/O device 208 each operatively connected for computer communication to a communications infrastructure 210. The processor 202 may include logic circuitry with hardware, firmware, and software architecture frameworks for facilitating the methods, functions, and components as described herein. In some embodiments, the processor 202 may store application frameworks, kernels, libraries, drivers, application program interfaces, among others, to execute and control hardware and functions discussed herein. In some embodiments, the memory 204 and/or the data store 206 may store similar components as the processor 202 for execution by the processing unit. The I/O device 208 may include one or more input-output devices for providing visual, audio, and/or tactile input and/or output from and/or to another entity (e.g., a user). The I/O device 208 may be a monitor, display, keyboards, touch screens, speakers, among other devices. The communications infrastructure 210 may include software and hardware to facilitate communication between the components of the computing system 200 and/or other components of a network and/or cloud service. Specifically, the communications infrastructure 210 may include network interface controllers, other hardware and software that manages and/or monitors connections, and/or controls bi-directional data transfer using, for example, a communication network.

Operation of the light track controlling system 100 will now be described. In FIG. 10, a method of operation 300 of a light track controlling system 100 is shown. The light track controlling system 100 utilizes the features described in the above description and claims with the associated figures. The method of operation 300 allows an animal enclosure to benefit from a moving heat and light source to emulate the sun’s travel pattern across the sky. At block 302 of the method of operation, a control module 133 transitions from standby mode to an active mode by supplying power to the light track controlling system 100. At block 304, the timer of the control module 133 is programmed with a desired time interval to energize and move a moveable carriage 150 using a motor 132 from a home position 146 near a home limit switch 112 to a return position 148 near a return limit switch 113, while supplying energy in the form of heat and light into an animal enclosure. At block 306, the moveable carriage 150 reaches the return position 148 near the return limit switch 113 and de-energizes the heat and light source after expiration of the time interval. At block 308, the motor 132 runs in reverse direction to bring the moveable carriage 150 back to the starting point at the home position 146. At block 310, the control module 133 commands the motor 132 to standby in the home position 146 until the next cycle after a predetermined time interval, whereupon the light source will remain in OFF mode.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as critical, required, or essential features or elements of any of all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact ether temporarily or permanently, although not necessarily directly and not necessarily mechanically. A device or structure that is “configured” in a certain way is configured in at least that way but may also be configured in ways that are not listed. The term “integral” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiment, e.g., E₁, E₂, …Eₙ and that each embodiment E may have multiple parts A₁, B₁, C₁, …Zₙ that (without further description) cold be combined with other embodiments Eₙ, embodiment parts, e.g. A₁, C₁, or lack of parts originally associated with one or all embodiments Eₙ, or any combination of parts and/or embodiments thereof. It should further be appreciated that an embodiment Eₙ may include only one part e.g. A₁ or a lesser number of parts e.g. B₁, C₁ of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes after having the benefit of reviewing the subject disclosure and accompanying drawings.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A light track apparatus for use with an animal enclosure, comprising:
a track positioned above the animal enclosure and extending along a length of the animal enclosure;
a moveable carriage coupled to the track and configured to move along the track;
a home limit switch located at a first end of the track and a return limit switch located at a second end of the track and opposite the first end;
a motor coupled to the moveable carriage; and
a control module electrically coupled to the motor,
wherein the control module includes a timer to control movement of the moveable carriage from a home position to a return position of the track.

2. The light track apparatus of claim 1, wherein the moveable carriage includes a light source.

3. The light track apparatus of claim 2, wherein a height of the light source is adjustable on the moveable carriage.

4. The light track apparatus of claim 2, wherein the light source includes at least two light sources.

5. The light track apparatus of claim 2, wherein the control module includes a dimmer to alter a luminescence and a heat output of the light source.

6. The light track apparatus of claim 2, wherein the control module includes a time-delay feature to enable the light source to begin operating at a preset time.

7. The light track apparatus of claim 2, wherein the control module further includes a UVB bulb outlet that is energized only when the light source on the moveable carriage is energized.

8. The light track apparatus of claim 2, further comprising a thermostat operatively coupled to infrared sensors, wherein the thermostat regulates a temperature within a basking zone of the animal enclosure based on temperature measurements from the infrared sensors.

9. The light track apparatus of claim 2, further comprising a power outlet on the control module, wherein the power outlet is energized during a time interval distinct from the time interval of the light source on the moveable carriage.

10. The light track apparatus of claim 1, wherein the timer commands the motor to advance the moveable carriage from the home position towards the return position for 12 hours per day.

11. A method of operation for a light track apparatus, comprising:
transitioning a control module from a standby mode to an active mode by supplying power to the light track apparatus;
programming a timer in the control module with a time interval for a moveable carriage to travel from a home position to a return position along a track;
energizing a motor to transfer the moveable carriage to the home position;
advancing the moveable carriage across a length of the track away from the home position for the time interval programmed in the timer, while simultaneously energizing a light source;
stopping advancement of the moveable carriage at the return position after the time interval has elapsed;
de-energizing the light source; and
returning the moveable carriage back to the home position.

12. The method of claim 11, wherein the light track apparatus is installed over an animal enclosure.

13. The method of claim 11, wherein the time interval is 12 hours.

14. The method of claim 11, further including programming a dimmer in the control module to alter a luminescence and a heat output from the light source.

15. The method of claim 11, further including a UVB light source coupled to the control module, wherein the UVB light source is energized for the same time interval as the light source.

16. A system for controlling a light track system for use in an animal enclosure, comprising:
a control module with an electrical power input and output, the control module coupled to a motor for moving a moveable carriage;
a home limit switch located at a first end of a track and a return limit switch located at a second end of the track and opposite the first end;
the moveable carriage configured to move on the track from a home position of the track to a return position of the track;
a light source energized while the moveable carriage is moving from the home position to the return position of the track;
wherein the moveable carriage is coupled to a belt that is connected to the motor, that when the motor is energized, moves the moveable carriage along the track; and
wherein the moveable carriage begins a cycle at the home position of the track and progresses to the return position of the track over a time interval that has been programmed into the control module through an interface on the control module, whereby the moveable carriage travels back to the home position after reaching the return position and remains at the home position until another cycle begins.

17. The system of claim 16, wherein the time interval that has been programmed into the control module is 12 hours.

18. The system of claim 16, wherein the motor is a step-motor that moves the moveable carriage from the home position to the return position in a step-wise manner over the time interval.

19. The system of claim 16, wherein the control module includes a UVB outlet configured to be energized only when the light source on the moveable carriage is energized while moving from the home position to the return position during the programmed time interval.

20. The system of claim 19, further comprising a dimmer feature through the control module, wherein the light source and the UVB outlet have separately programmable time intervals, and wherein the light source and the UVB outlet are separately dimmable.
